(19) United States
(12) Patent Application Publication
(10) Pub. No.: US 2009/0243549 A1
(43) Pub. Date: Oct. 1, 2009

(54) INTELLIGENT BATTERY CHARGING RATE MANAGEMENT

(76) Inventors: Naoki Matsumura, Tokyo (JP); Nobuhiro Otani, Chiba-ken (JP); Kiyohiro Hamaji, Ibaraki-ken (JP)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/059,967

(22) Filed: Mar. 31, 2008

(51) Int. Cl. H02J 7/00

(52) U.S. Cl. 320/155

(57) ABSTRACT

A method and system for intelligent battery charging rate management. Some embodiments of a method include determining a time period available for charging a rechargeable battery from an initial charge state to a final charge state. A second time period is determined, the second time period being an amount of time required to charge the battery from the initial charge state to the final charge state using a first charging process, with the first charging process including a first current value. If the first time period is greater than the second time period, then a reduced second current value is determined that is sufficient to charge the battery to the final charge state, and the battery is charged with a current of the second current value.

### FIELD

Embodiments relate to rechargeable storage batteries. More particularly, embodiments relate to a system and method for intelligent battery charging rate management.

### BACKGROUND

Rechargeable batteries are utilized in a vast array of devices and products. In particular, laptop and notebook computers and similar devices utilize batteries that are relied upon to provide portable computing power. Other devices include portable electronic devices such as handheld computers and personal digital assistants (PDAs), cellular telephones and similar communication devices, music and video systems, gaming systems, and many others.

All such devices have in common a battery that requires fairly frequent recharging, and that, unfortunately requires periodic replacement. Batteries have a limited lifespan, and can be charged and discharged only a certain number of times, with the battery capacity gradually fading as charge and discharge cycles are completed. Such batteries may be expensive to purchase, and may be difficult to remove and replace in many devices. When batteries ultimately fail, there is an additional environmental issue of safe recycling and disposal of used batteries, which becomes a larger societal issue as more devices are produced.

The charge rate used for recharging of rechargeable batteries has an impact on the length of the lifespan of the batteries, with a slower charge generally being better. However, there is countervailing issue, which is the desire for quick charging to allow frequent and reliable use of the electronic device. If the recharging process is extended too long, then the device at issue becomes less useful. For this reason, charge rates are often relatively quick, which favors device usage and convenience over the lifespan of battery systems.

### BRIEF DESCRIPTION OF THE DRAWINGS

Embodiments are illustrated by way of example, and not by way of limitation, in the figures of the accompanying drawings in which like reference numerals refer to similar elements:

FIG. 1 is an illustration of a device including an embodiment of an apparatus or system including a battery charging rate management system;

FIG. 2 is a flowchart to illustrate an embodiment of a battery charging rate management process;

FIG. 3 is an illustration of an embodiment of battery charging rate management processes and

FIG. 4 provides a schematic diagram of an embodiment of an apparatus or system including an intelligent charging rate management system.

### DETAILED DESCRIPTION

An embodiment concerns intelligent battery charging rate management.

As used herein:

“Battery” means any device that generates electrical potential through a chemical reaction. In particular, a battery includes a rechargeable battery that may be restored to operation by a charging operation. Batteries may include, but are not limited to, nickel cadmium (NiCad), lithium ion (Li-ion), and other rechargeable batteries.

“Mobile computing device” means any personal computer or similar computing device that provides mobile operation and that includes a rechargeable battery power source. The term mobile computing device may include, but is not limited to, a notebook or laptop computer, handheld computer, tablet PC, ultra-mobile personal computer (UMPC), mobile Internet device (MID), smartphone, personal digital assistant (PDA), or other similar device.

“Battery pack” means a package of one or more battery cells. Battery packs are commonly used in operation of many electronic devices, include mobile computing devices.

“Battery control unit” means a unit to control certain operations of a battery. A battery pack may include a battery control unit.

In some embodiments, an intelligent battery charging rate management system is provided. In some embodiments, a system determines a current value used for battery charging based on factors that include, but are not limited to, an amount of time available for charging. In some embodiments, a battery charging system chooses a charging current to extend long-term battery life while also completing the charging process within a time period that is available for charging.

In normal operation, a battery pack of a notebook PC (NBPC), an ultra mobile PC (UMPC), or other device is charged when an AC adapter is connected to the device. The battery pack is discharged when the device is battery-operated. In addition, the charge in the battery pack will eventually dissipate over time even when the device is not operated because of normal leakage processes. The time for charging a battery pack may vary depending on certain factors, including the amount of current used in battery charging. However, charging a battery more quickly can reduce the operational life of the battery, thus requiring more frequent replacement of expensive battery packs.

In an example, a battery pack may be an existing Li-ion battery, such as a battery pack that requires charging up to a level of 4.2V per battery cell. The battery begins at an initial charge state. In a common process, the battery may be charged through constant current charge (CC) at a predetermined fraction (generally 0.7) of “C” (indicating the “C-rate”) until a certain point is reached, which is then followed by constant voltage charge (CV) at 4.2V per battery cell. The C-rate is the normalized current, which is the battery capacity/1 hour, where capacity is the battery capacity expressed in Amp-hours or mA-hour. For example, if a 3000 mAh battery cell is assumed, 1.0 C would be equal to 300 mA and 0.2 C would be equal to 600 mA. This common charging method is referred to as a “CC-CV charge”. A CC-CV charge commonly takes from 2.5 to 4.0 hours for charge completion.

When a device is operated on battery power, the battery pack is generally discharged down to a certain voltage, such as 3.0V per battery cell, before the battery pack requires recharging. Thus, a generic voltage range of a battery cell in a rechargeable battery pack is approximately from 3.0V to 4.2V per battery cell.

However, battery capacity gradually fades as charge and discharge cycles occur. For example, the capacity of a battery cell decreases to roughly 60% of the initial capacity after between 300 and 500 normal charge/discharge cycles due to chemical and mechanical degradation of the battery cell. For this reason, the overall usable run-time of a device operating on battery power will gradually decreases as a user charges and discharges the battery pack in normal device usage.

Certain devices, including mobile computing devices, employ software, firmware, or hardware to restrict the charge termination level in order to extend the battery cycle life. For example, a system may reduce the charge termination voltage in response to a user changing an initial charge setting with the system. However, when this setting is effective, full charge capacity is lower (such as 80% of the maximum) than that when the setting is not effective. Therefore, while extended battery life results in terms of the number of cycles available, shorter run-time in each cycle results because a full charge state is not being reached.

In some embodiments, a device, system, or process provided a mechanism to extend battery cycle life, without reducing the run-time provided by the battery in each cycle. In some embodiments, a system controls charging current depending on the existing conditions to mitigate current stress on battery life and to extend cycle life. In some embodiments, the charging current is based on factors that include the time available for charging the battery. In some embodiments, the system may include software, hardware, or a combination of software and hardware.

In some embodiments, a time for charging may be input into a system or determined based on certain factors. In some embodiments, a battery charging rate management system enables a user to establish or set certain time points, such as via a user interface, that are then used to determine the time available for battery charging. A first time point X may be the start of charging, which may, for example, be the time at which a user plugs in an AC adapter for a battery pack or device containing a battery (referred to here generally as a battery), and thus may be set automatically. In other embodiments, time point X might be set via another action by the user, or by a user input setting. Time X may be also set by or through use of a user-independent device, such as an optical sensor that detects darkness, and thus determines that a battery is being charged overnight. However, embodiments are not restricted to any particular method or process for setting X. A second time point Y may be the expected end of charging, which may be, for example a time at which a user is expected unplug an AC adapter or otherwise end the charging cycle for the battery. In some embodiments, Y may be set by the user, such as a setting of a particular time when the user expects to remove the battery from the charger. In some embodiments, the Y value may vary day to day, and in other embodiments Y may be set to be a particular time each day.

In some embodiments, a system calculates the difference between time points X and Y or otherwise obtains a time for charging, and arrives at a result of Z hour(s) that are available to charge the battery from the initial charge state to the final charge state. In some embodiments, the system further determines a time that is needed to charge the battery to a final charge state (which may be, but is not limited to, a fully charged state) using a conventional CC-CV charge process, with the result being a certain P hour(s).

In some embodiments, if Z is greater than P, the system decreases the charge current during a CC process to mitigate the current stress on battery life. In some embodiments, the system determines a current level that is sufficient to charge the battery to the desired final charge state with in Z hours. Thus, the total charging time is less than or equal to Z. In some embodiments, a system may attempt to end the charge as close to Z as possible to minimize current, and in other embodiments the charging time may be some amount less than Z to ensure that the battery is fully charged or nearly fully charged when the charging cycle is ended by the user. In some embodiments, if Z is less than or equal to P, the system may then utilize a conventional cycle, such as the conventional CC-CV charging cycle. While the description here relates to a CC-CV charging cycle, embodiments are not limited to any particular type of charge cycle.

In some embodiments, an intelligent battery charging rate management device, module, or system may be implemented in multiple different locations. For example, the locations may include, but are not limited to, a point that is between an AC/DC adapter and a battery pack. In some embodiments, the device, module, or system may be a part of a battery charger. In some embodiments, the device, module, or system may be a part of a device, such as a mobile computer device, containing a rechargeable battery. In some embodiments, the device, module, or system may be a separate unit from a rechargeable device and from the AC/DC adapter.

In an example, an intelligent battery charging rate management device, system, or process for charging a battery using a CC-CV charge may be as follows:

(1) The standard charging process is a CC-CV charge as follows:

CC: constant current at 0.7 C to 4.2V/cell

CV: constant voltage at 4.2V/cell until current drops below 0.02 C.

(2) A user established a first time point X (e.g., 12:00 midnight) and a second time point Y (e.g. 5:00 AM), where X is the time to start an overnight charge and Y is the time to end the charging cycle in the morning. As described above, X and Y may be set via multiple different mechanisms.

(3) In this instance Z is calculated as 5 hours, where Y−X=Z.

(4) The user plugs the battery into an AC adapter at 12:00 midnight, and goes to bed. In this example, it is assumed that the battery pack of the user is fully discharged, but it may be at any charge state. In this instance, the charging process at this state will take a 3 hour for charge completion using a normal CC-CV charge process, and thus P=3.0.

(5) Because Z>P, the process, apparatus or system then determines a reduced current for the charging of the battery that is sufficient to charge the battery within the Z time period. In this instance, the charging current during CC is reduced from 0.7 C to 0.3 C, which, under these circumstances, the system determines provides a total charging time to charge completion that is near Z hours. The time and current depend on the individual charging characteristics of the battery. By reducing the charging current, degradation of battery capacity is mitigated, which extends cycle life.

In an example, the effect of an intelligent battery charging rate management process may be addressed experimentally. In this example, cycle tests may be conducted on battery samples A and B, with A and B having the same initial capacity. In this example, test conditions may be as follows:

Sample A:

Cycled 300 times at 25 degrees C.

Charge: Sample A is charged at 0.5 C up to 4.2V, followed by constant voltage charge at 4.2V until current drops below 50 mA.

Rest time: 20 minutes

Discharge: Sample A was discharged at 1 C to 2.5V.

Rest time: 20 minutes

Sample B:

Cycled 300 times at 25 deg. C. Charge: Sample B is charged at 0.3 C up to 4.2V, followed by constant voltage charge at 4.2V until current drops below 50 mA.

Rest time: 20 minutes

Discharge: Sample B was discharged at 1 C to 2.5V

Rest time: 20 minutes

In this example, after 300 cycles, it may be shown that sample A retains approximately 41% of initial capacity, while sample B retains approximately 83% of initial capacity, with the actual results depending on the charging characteristics of the batteries being examined. Embodiments are not limited to any particular battery or resulting modification in capacity.

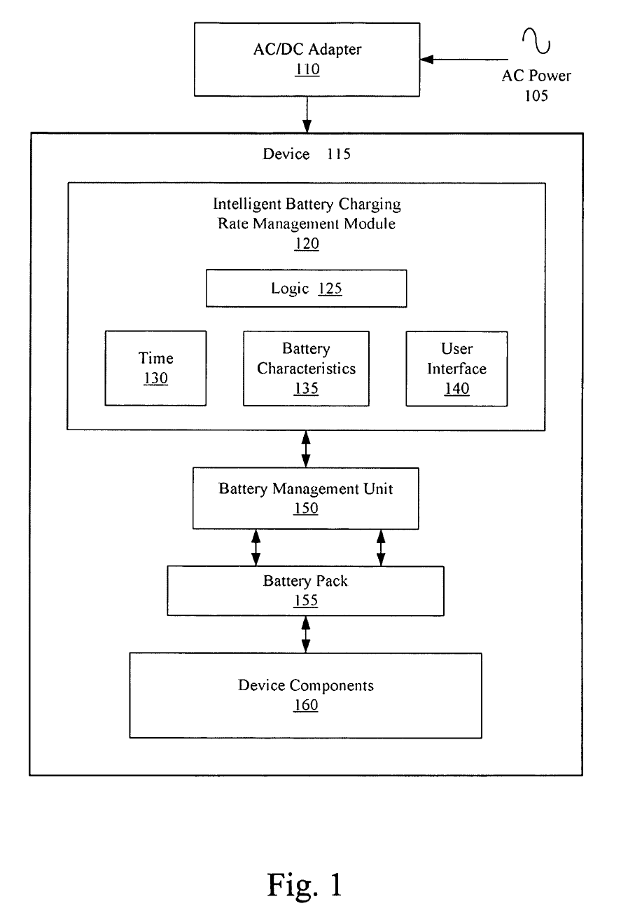

FIG. 1 is an illustration of a device including an embodiment of an apparatus or system including a battery charging rate management system. In this illustration, a device 115, which may include, but is not limited to, a mobile computing device, includes a battery charging rate management module 120 to manage the charging of batteries. The batteries may be in a battery pack 155, which may include or be coupled with a battery management unit 150. The battery pack 155 may provide power to device components 160 while the device is not plugged into power source. If the device 115 is a mobile computing device, the device components include the processor, memory, communication interfaces, and any other powered components. The device 115 may receive power from an AC/DC adapter or transformer 110, which converts AC power from a power source 105 (generally from an electrical wall outlet) to DC power. The adapter 110 may be part of the device 115 or may be a separate unit or system.

In some embodiments, the battery charging rate management module 120 operates to determine a time period available for charging the battery pack 155 from an initial charge state to a final charge state, to determine a time period to charge the battery pack 155 in a standard process, and, if the time available for charging is greater than the time required for the standard process, determining a reduced current for charging that will result in a charging rate that is sufficient to complete the charging process within the time available. The module 120 may include logic 125, which may include one or more logic elements, to make the determinations regarding time periods and regarding current levels. In one example, logic 125 may include a first logic to determine the time period available for charging the battery pack 155 and the time period to charge the battery pack in the standard process, and a second logic to determine the reduced current for charging in the available time. The module 120 may further include a time element 130 that provides the current time, which may be used in determining the time that is available for charging. The module 120 may further include a battery charging characteristics element 135, which includes data or values representing the charging characteristics of the battery pack and which may be used in determining the current value needed for battery charging. The module 120 may include a user interface 140 to allow a user to input time values used in determining the time available for battery charging.

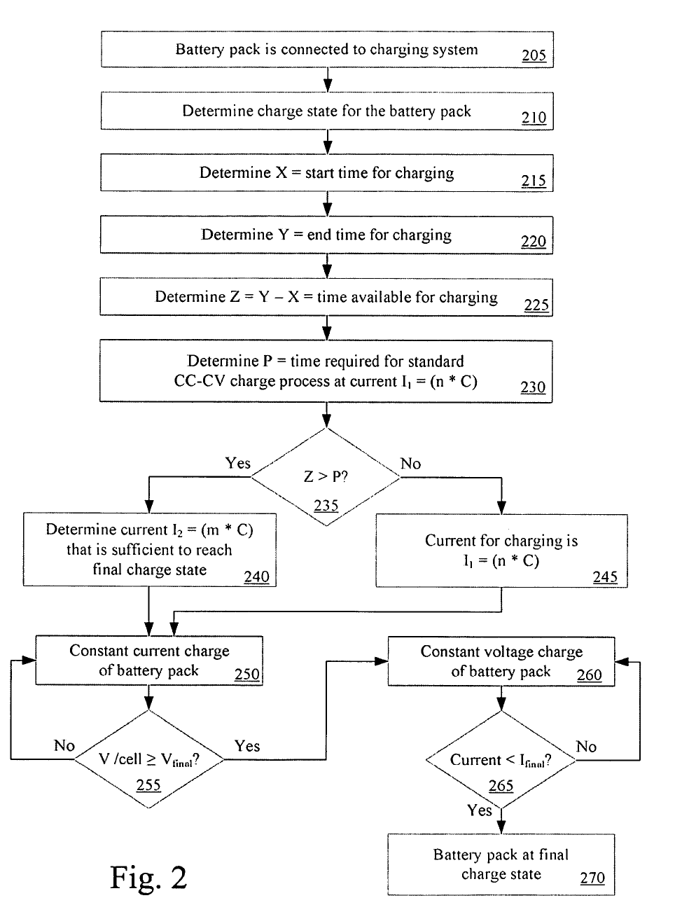

FIG. 2 is a flowchart to illustrate an embodiment of a battery charging rate management process. In this illustration, a battery pack is connected to a charging system 205. This may be accomplished by plugging a device containing the battery into a power adapter, placing the battery into a separate charger, or otherwise connecting the battery for charging. In some embodiment, a system will determine the current charge state for the battery pack 210, which generally will involve measuring the current voltages of the battery cells.

In some embodiments, a time available for battery charging is determined. As illustrated in FIG. 2, a time X for starting the charging process is determined 215. The time may simply be the present time at which the battery is connected to the charging system or a charging process actually begins, but also may include a later time if there is a delay before the battery pack is charged. In some embodiments, a time Y that is expected for ending the charging process is determined 220. In some embodiments, the expected ending time Y may be input by a user, and may be stored in the charging system for future use. In other embodiments, time X and time Y may be determined by other means, such as by a sensor that determines that a battery is being charged overnight, and determines X and Y accordingly.

In some embodiments, a time Z equal to the difference between end time Y and start time X is determined 225, Z thus being the amount of time that is available to charge the battery pack. A time P is also determined, P being the amount of time that would be required to charge the battery pack from the current charge state to the final charge state at a standard charge process 230, which may be, as indicated above I₁=0.7° C., where C (the C-rate) is the amp-hour rating for the battery. If available time Z is greater than the time P needed for standard charging 235, then it is possible to charge the battery pack to a final charge state (which may be, but is not limited to, a fully charged state). In this case, a current is determined that is sufficient to produce a charging rate that will cause the battery to reach the final charge state during the Z time period 240. If Z is not greater than P, then the current for charging is a standard current, such as I₁=0.7° C., element 245. With the appropriate current value, the system then charges the battery pack. In some embodiments, the charge process includes applying a constant current charge to the battery pack 250 until a certain voltage per cell, here referred to as V_{final}, is reached 255. V_{final} may be, for example, 4.2 volts per battery cell. At this point, the charging process may include a constant voltage charge to the battery pack, such as 4.2 volts per battery cell, until the current is reduced to a final current, referred to here as I_{final}, which may be, for example, 50 mA.

While for simplicity the embodiments illustrated here provide for single determination of the current for charging and a single constant current that is used, this may vary in other embodiments. For example, a charging process can begin at a standard current and then be reduced to another current after a later determination. In addition, a charging process may include a varying current, such as a current that is gradually reduced as the battery pack gets closer to a final voltage value.

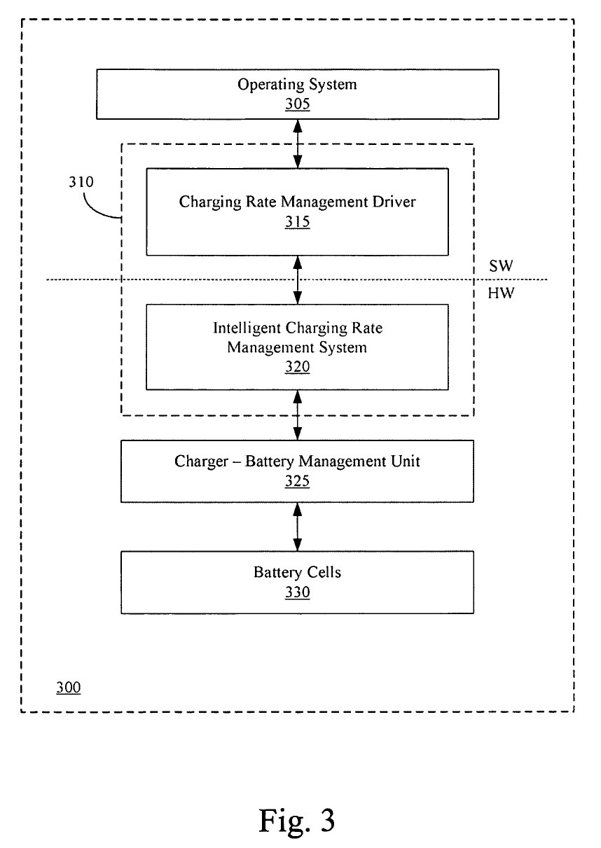

FIG. 3 is an illustration of an embodiment of battery charging rate management processes. In this illustration, a charging rate management system 310 is illustrated in an apparatus or system including an operating system, such as a mobile computing system or similar apparatus or system having a general purpose processor. However, embodiments are not limited to such systems. For example, embodiments may further include devices that do not include general purpose processors, such as a consumer electronic device, and that includes a separate logic or processor to operate the charging rate management system. Further, embodiments may include chargers that include the charging rate management system and are separate from the apparatus or device containing the batteries to be charged.

In this illustration, the apparatus or device 300 includes a charging module 310 that provides for management of the operation of a battery charger and battery management unit 325 for the charging of battery cells 330. The charging module may include hardware, software, or a combination of hardware and software. In some embodiments, the charging module 310 includes an intelligent charging rate management system 320, which may be a hardware element, and a charging rate management driver 315, which may be a software element. The charging management driver 315 may provide for operation of the charging rate management system 320 using an operating system 305 of the apparatus or system 300.

In some embodiments, the charging rate management system 320 provides for determining a reduced current that may be used to charge the battery cells. In some embodiments, the charging rate management system 320 determines the reduced current by determining a length of time available for charging of the battery cells, comparing the length of time available to a length of time required for charging the battery cells to a final charge state using a standard charging process, and, if the available time is greater than the time required for the standard process, determining a current value for charging that is sufficient to complete the charging process during the available time period.

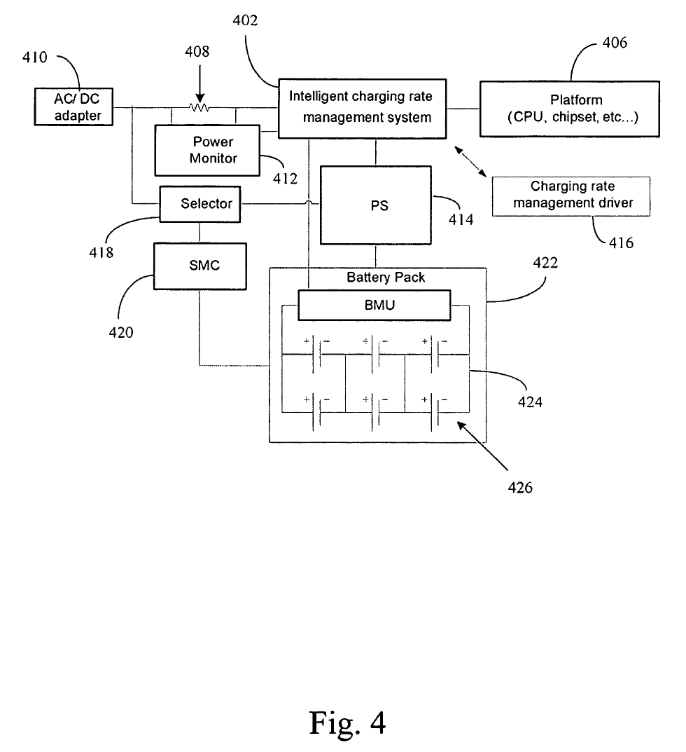

FIG. 4 provides a schematic diagram of an embodiment of an apparatus or system including an intelligent charging rate management system. In this illustration, an AC/DC adapter 410 may provide power for battery charging, such as the charging of a battery pack 422. The battery pack 422 may include a battery management unit 424 and multiple battery cells 426. A power monitor 412 may monitor power, shown as monitoring power across a system resistance 408. The power output of the adapter 410 is also connected to a selector 418 to select operation of a power switch (PS) 414 coupled with the battery pack 422, and thus to control the charging of the battery pack 422. A system management controller (SMC) 420 is used to interface with the battery pack. The SMC 420 operates to control the selector 418.

In some embodiments, an intelligent charging rate management system 402 provides for management of the rate of charging of the battery pack 422. In some embodiments, the charging rate management system 402 operates together with a charging rate management driver 416 to determine a time period available for charging of the battery pack 422, and, if the time period is greater than a time period required for a standard charging process, to determine a reduced current that is sufficient to charge the battery to a final charge state during the time period available for charging the battery pack. In some embodiments, the charging rate management system 402 operates with a system platform 406 (including the central processing units (CPUs), chipset, and other elements) to manage the charging rate for the battery pack.

Those skilled in the art having the benefit of this disclosure will appreciate that many other variations from the foregoing description and drawings may be made within the scope of certain embodiments. Indeed, embodiments are not limited to the details described above. Rather, it is the following claims including any amendments thereto that define the scope of the embodiments.

In the description above, for the purposes of explanation, numerous specific details are set forth in order to provide a thorough understanding. It will be apparent, however, to one skilled in the art that embodiments may be practiced without some of these specific details. In other instances, well-known structures and devices are shown in block diagram form.

Certain embodiments may include various processes. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of certain embodiments may be provided as a computer program product, which may include a computer-readable medium having stored thereon instructions, which may be used to program a processor to perform a process. The computer-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, an embodiment may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that embodiments require more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment.

What is claimed is:

1. A method comprising:
determining a first time period, the first time period being an amount of time available for charging a rechargeable battery from an initial charge state to a final charge state;
determining a second time period, the second time period being an amount of time to charge the battery from the initial charge state to the final charge state using a charging process, the charging process including a first current value;
if the first time period is greater than the second time period, determining a second current value that is sufficient to charge the battery to the final charge state during the first time period, the second current value being less than the first current value; and
charging the battery, charging the battery including charging with a current of the second current value.

2. The method of claim 1, wherein determining the first time period includes determining a start time for charging and determining an ending time for charging.

3. The method of claim 1, wherein determining the second time period includes retrieving charging characteristic information for the battery.

4. The method of claim 1, wherein the battery is a lithium ion battery.

5. The method of claim 1, wherein the charging process is a CC-CV (constant current-constant voltage) charging process.

6. The method of claim 5, wherein the first current value is a predetermined fraction of the amp-hour value of the battery.

7. The method of claim 1, wherein the battery is contained in an electronic device.

8. A battery charging rate management system comprising:
a first logic to determine a first time period available for charging a rechargeable battery to a final charge state, and to determine a second time period to charge the battery from an initial charge state to the final charge state in a charging process at a first current value, and
a second logic to determine, if the first time period is greater than the second time period, a second current value that is sufficient for charging the rechargeable battery from the initial charge state to the final charge state during the first time period.

9. The system of claim 8, further comprising data regarding charging characteristics of the rechargeable battery, the second logic to base the determination of the second current value at least in part on the data regarding charging characteristics.

10. The system of claim 8, wherein the final charge state is a full charge for the battery.

11. The system of claim 8, further comprising a user interface, wherein the first logic is to determine the first time period by comparing a time to start charging from a time to complete charging, and wherein a user is to input the time to complete charging through the user interface.

12. The system of claim 8, wherein the charging process is a CC-CV (constant current-constant voltage) charging process.

13. The system of claim 8, wherein the battery is a battery pack containing a plurality of battery cells.

14. The system of claim 8, wherein the system is a part of a mobile computing device.

15. The system of claim 8, further comprising a charger to provide power for charging the battery.
